(19) United States
(12) Patent Application Publication
(10) Pub. No.: US 2017/0226324 A1
(43) Pub. Date: Aug. 10, 2017

(54) MODIFIED POLYMER COMPOSITION AND STABILIZER MIXTURE FOR MAKING THE SAME

(71) Applicant: FDC, Lees Chemical Industry Co., Ltd., Taipei City (TW)

(72) Inventors: Kun-Chang Lee, Taipei City (TW); Chen-Kai Chen, Taipei City (TW); Jen-Fu Wang, Taipei City (TW)

(21) Appl. No.: 15/417,719

(22) Filed: Jan. 27, 2017

(30) Foreign Application Priority Data
Feb. 4, 2016 (TW) 105103696
Aug. 19, 2016 (TW) 105126497

(51) Int. Cl. C08K 5/5393; C09K 15/32; C08K 5/372; C09K 15/12; C08K 5/526; C08K 5/527

(52) U.S. Cl. CPC C08K 5/5393; C08K 5/526; C08K 5/527; C08K 5/372; C09K 15/12; C09K 15/324

(57) ABSTRACT

Disclosed herein is a stabilizer mixture for modifying an olefin-based polymer, which comprises at least one organic phosphorus-containing antioxidant represented by a formula selected from the group consisting of formulae (1), (2), (3), (4), (5), (6), (7), and (8), as well as at least one sulfur-containing carboxylate salt represented by a formula selected from the group consisting of formulae (9), (10), (11), and (12). Also disclosed herein is a modified polymer composition prepared from an olefin-based polymer using the stabilizer mixture. The olefin-based polymer is selected from the group consisting of polyolefin, ethylene-vinyl acetate copolymer, and a combination thereof.

### CROSS-REFERENCE TO RELATED APPLICATION

This application claims priority of Taiwanese Patent Application Nos. 105126497, filed on Aug. 19, 2016 and 105103696, filed on Feb. 4, 2016. The contents of both applications are hereby incorporated by reference in their entirety.

### FIELD

The disclosure relates to a modified polymer composition, and more particularly to a modified polymer composition prepared from an olefin-based polymer using a stabilizer mixture which contains at least one organic phosphorus-containing antioxidant and at least one sulfur-containing carboxylate salt.

### BACKGROUND

Olefin-based polymers, such as polyolefins and ethylene-vinyl acetate copolymers, are widely used for making various products, because they have good chemical stability, mechanical strength, electrical insulating ability, and dimensional stability and they are non-toxic and easily processable. However, olefin-based polymers have defects, such as susceptibility to discoloration (for example, yellowing) and reduced mechanical properties, due to oxidative degradation caused by heat, light, and oxygen.

It is well-known that an antioxidant may be used in a process for manufacturing a molding product from an olefin-based polymer to prevent the olefin-based polymer from oxidative degradation so as to enhance the mechanical property and thermal resistance of the olefin-based polymer. However, use of antioxidants might result in coloration and reduced processing stability of olefin-based polymers. In addition, an anti-acid agent may be used in a process for manufacturing a molding product from an olefin-based polymer to inhibit the degradation of the olefin-based polymer by an acidic substance. Nevertheless, acidic substances might result in coloration and reduced processing stability of olefin-based polymers.

### SUMMARY

According to a first aspect of the disclosure, there is provided a stabilizer mixture for modifying an olefin-based polymer, which comprises:

at least one organic phosphorus-containing antioxidant represented by a formula selected from the group consisting of formulae (1), (2), (3), (4), (5), (6), (7), and (8),

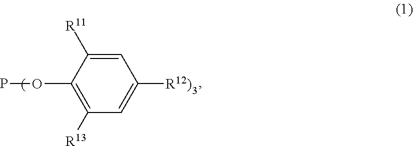

wherein R¹¹, R¹², and R¹³ are independently selected from the group consisting of hydrogen, a tert-butyl group, an isopropylphenyl group, and a linear C₁-C₈ alkyl group,

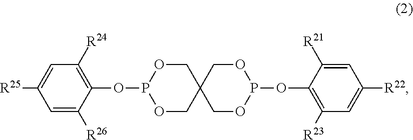

wherein R²¹, R²², R²³, R²⁴, R²⁵, and R²⁶ are independently selected from the group consisting of hydrogen, a tert-butyl group, an isopropylphenyl group, and a linear C₁-C₈ alkyl group,

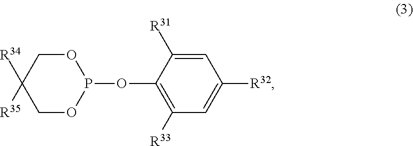

wherein R³¹, R³², R³³, R³⁴, and R³⁵ are independently selected from the group consisting of hydrogen, a tert-butyl group, an isopropylphenyl group, and a linear C₁-C₈ alkyl group,

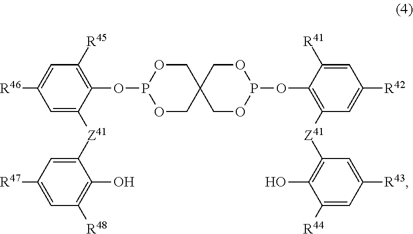

wherein

R⁴¹, R⁴², R⁴³, R⁴⁴, R⁴⁵, R⁴⁶, R⁴⁷, and R⁴⁸ are independently selected from the group consisting of hydrogen, a tert-butyl group, an isopropylphenyl group, and a linear C₁-C₈ alkyl group, and

Z⁴¹ and Z⁴² are independently selected from the group consisting of O, S, and a C₁-C₄ alkylene group,

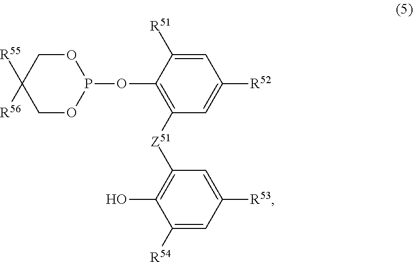

wherein

R⁵¹, R⁵², R⁵³, R⁵⁴, R⁵⁵, and R⁵⁶ are independently selected from the group consisting of hydrogen, a tert-butyl group, an isopropylphenyl group, and a linear C₁-C₈ alkyl group, and

Z⁵¹ is selected from the group consisting of O, S, and a C₁-C₄ alkylene group,

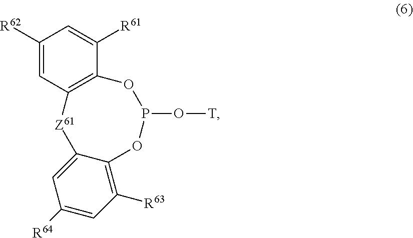

wherein

R⁶¹, R⁶², R⁶³, and R⁶⁴ are independently selected from the group consisting of hydrogen, a tert-butyl group, an isopropylphenyl group, and a linear C₁-C₈ alkyl group, and

Z⁶¹ is selected from the group consisting of O, S, and a C₁-C₄ alkylene group,

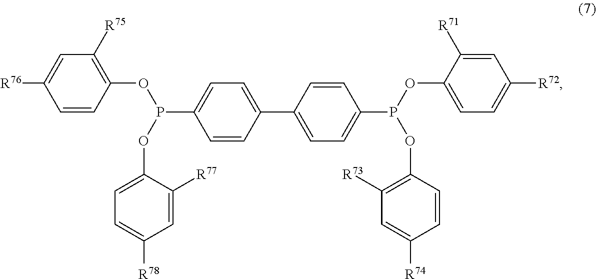

wherein R⁷¹, R⁷², R⁷³, R⁷⁴, R⁷⁵, R⁷⁶, R⁷⁷, and R⁷⁸ are independently selected from the group consisting of hydrogen, a tert-butyl group, an isopropylphenyl group, and a linear C₁-C₈ alkyl group, and

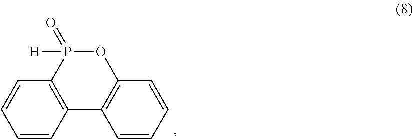 [SMILES: O=[PH]1Oc2ccccc2-c2ccccc21]

and

at least one sulfur-containing carboxylate salt represented by a formula selected from the group consisting of formulae (9), (10), (11), and (12)

[R⁹²—S—CHR⁹¹—(CH₂)ₜ—COO⁻]_{q}M^{q+} (9),

wherein

R⁹¹ is selected from the group consisting of hydrogen and a C₁-C₁₈ alkyl group,

R⁹² is selected from the group consisting of a C₁-C₃₀ alkyl group, a C₆-C₁₈ aryl group, and a group represented by R⁹³OOC—(CH₂)ₖ— where R⁹³ is selected from the group consisting of a C₁-C₃₀ alkyl group and a C₆-C₁₈ aryl group, and k is an integer ranging from 1 to 5,

M^{q+} is selected from the group consisting of Ca²⁺, Ba²⁺, Mg²⁺, Zn²⁺, and Al³⁺,

q is an integer of 2 or 3, and

t is an integer ranging from 0 to 6,

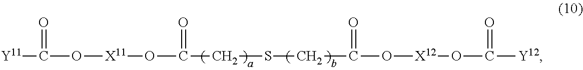

wherein

X¹¹ and X¹² are independently selected from the group consisting of Ca²⁺, Ba²⁺, Mg²⁺, and Zn²⁺,

Y¹¹ and Y¹² are independently selected from the group consisting of a C₁-C₃₀ alkyl group and a C₆-C₁₈ aryl group, and

a and b are independently an integer ranging from 1 to 6,

H-G¹-X²¹ₚ-G²-H (11),

wherein

X₂₁ is selected from the group consisting of Ca²⁺, Ba²⁺, Mg²⁺, and Zn²⁺,

G¹ and G² independently represent

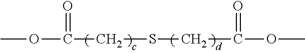

where c and d are independently an integer ranging from 1 to 6, and

p is an integer ranging from 1 to 9 on the proviso that a plurality of G¹ are the same or different and a plurality of X²¹ are the same or different when p is an integer equal to or larger than 2,

and

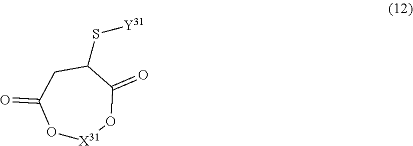

wherein

X³¹ is selected from the group consisting of Ca²⁺, Ba²⁺, Mg²⁺, and Zn²⁺, and

Y³¹ is selected from the group consisting of a C₁-C₃₀ alkyl group, a C₆-C₁₈ aryl group, and a group represented by R⁹³OOC—(CH₂)ₖ— where R⁹³ is selected from the group consisting of a C₁-C₃₀ alkyl group and a C₆-C₁₈ aryl group, and k is an integer ranging from 1 to 5.

According to a second aspect of the disclosure, there is provided a modified polymer composition prepared from an olefin-based polymer using the aforesaid stabilizer mixture. The olefin-based polymer is selected from the group consisting of polyolefin, ethylene-vinyl acetate copolymer, and a combination thereof.

### DETAILED DESCRIPTION

The present disclosure provides a stabilizer mixture for modifying an olefin-based polymer, which comprises at least one organic phosphorus-containing antioxidant and at least one sulfur-containing carboxylate salt.

According to the present disclosure, the at least one organic phosphorus-containing antioxidant is represented by a formula selected from the group consisting of formulae (1), (2), (3), (4), (5), (6), (7), and (8), which are shown below. In other words, the organic phosphorus-containing antioxidant in the stabilizer mixture may be selected from the group consisting of the organic phosphorus-containing antioxidant of formula (1), the organic phosphorus-containing antioxidant of formula (2), the organic phosphorus-containing antioxidant of formula (3), the organic phosphorus-containing antioxidant of formula (4), the organic phosphorus-containing antioxidant of formula (5), the organic phosphorus-containing antioxidant of formula (6), the organic phosphorus-containing antioxidant of formula (7), the organic phosphorus-containing antioxidant of formula (8), and combinations thereof.

The organic phosphorus-containing antioxidant represented by formula (1) is as follows:

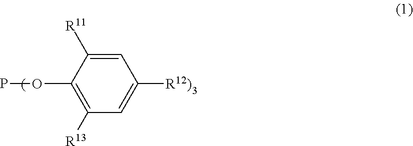

wherein R¹¹, R¹², and R¹³ are independently selected from the group consisting of hydrogen, a tert-butyl group, an isopropylphenyl group, and a linear C₁-C₈ alkyl group.

The organic phosphorus-containing antioxidant represented by formula (2) is as follows:

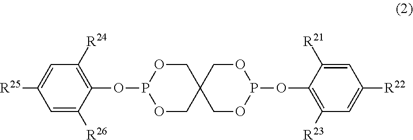

wherein R²¹, R²², R²³, R²⁴, R²⁵, and R²⁶ are independently selected from the group consisting of hydrogen, a tert-butyl group, an isopropylphenyl group, and a linear C₁-C₈ alkyl group.

The organic phosphorus-containing antioxidant represented by formula (3) is as follows:

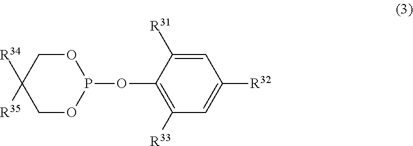

wherein R³¹, R³², R³³, R³⁴, and R³⁵ are independently selected from the group consisting of hydrogen, a tert-butyl group, an isopropylphenyl group, and a linear C₁-C₈ alkyl group.

The organic phosphorus-containing antioxidant represented by formula (4) is as follows:

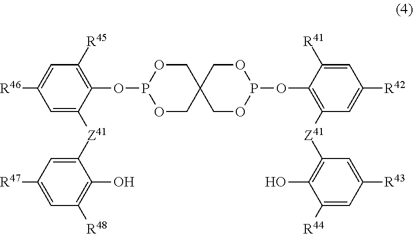

wherein R⁴¹, R⁴², R⁴³, R⁴⁴, R⁴⁵, R⁴⁶, R⁴⁷, and R⁴⁸ are independently selected from the group consisting of hydrogen, a tert-butyl group, an isopropylphenyl group, and a linear C₁-C₈ alkyl group, and Z⁴¹ and Z⁴² are independently selected from the group consisting of O, S, and a C₁-C₄ alkylene group.

The organic phosphorus-containing antioxidant represented by formula (5) is as follows:

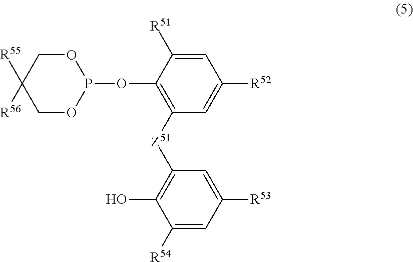

wherein R⁵¹, R⁵², R⁵³, R⁵⁴, R⁵⁵, and R⁵⁶ are independently selected from the group consisting of hydrogen, a tert-butyl group, an isopropylphenyl group, and a linear C₁-C₈ alkyl group, and Z⁵¹ is selected from the group consisting of O, S, and a C₁-C₄ alkylene group.

The organic phosphorus-containing antioxidant represented by formula (6) is as follows:

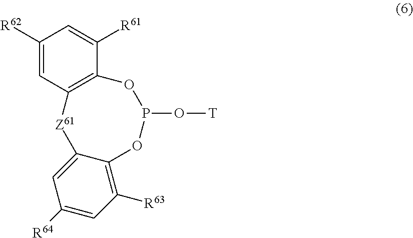

wherein R⁶¹, R⁶², R⁶³, and R⁶⁴ are independently selected from the group consisting of hydrogen, a tert-butyl group, an isopropylphenyl group, and a linear C₁-C₈ alkyl group, and Z⁶¹ is selected from the group consisting of O, S, and a C₁-C₄ alkylene group.

The organic phosphorus-containing antioxidant represented by formula (7) is as follows:

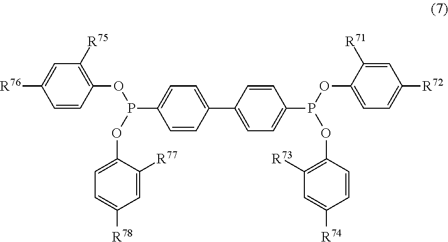

wherein R⁷¹, R⁷², R⁷³, R⁷⁴, R⁷⁵, R⁷⁶, R⁷⁷, and R⁷⁸ are independently selected from the group consisting of hydrogen, a tert-butyl group, an isopropylphenyl group, and a linear C₁-C₈ alkyl group.

The organic phosphorus-containing antioxidant represented by formula (8) is as follows:

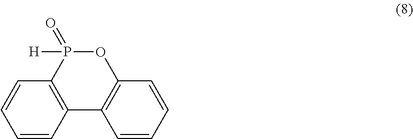 [SMILES: O=[PH]1Oc2ccccc2-c2ccccc21]

According to the present disclosure, the at least one sulfur-containing carboxylate salt is represented by a formula selected from the group consisting of formulae (9), (10), (11), and (12), which are shown below. In other words, the sulfur-containing carboxylate salt in the stabilizer mixture may be selected from the group consisting of the sulfur-containing carboxylate salt of formula (9), the sulfur-containing carboxylate salt of formula (10), the sulfur-containing carboxylate salt of formula (11), the sulfur-containing carboxylate salt of formula (12), and combinations thereof.

The sulfur-containing carboxylate salt represented by formula (9) is as follows:

[R⁹²—S—CHR⁹¹—(CH₂)ₜ—COO⁻]_{q}M^{q+} (9)

wherein R⁹¹ is selected from the group consisting of hydrogen and a C₁-C₁₈ alkyl group; R⁹² is selected from the group consisting of a C₁-C₃₀ alkyl group, a C₆-C₁₈ aryl group, and a group represented by R⁹³OOCC—(CH₂)ₖ— where R⁹³ is selected from the group consisting of a C₁-C₃₀ alkyl group and a C₆-C₁₈ aryl group, and k is an integer ranging from 1 to 5; M^{q+} is selected from the group consisting of Ca²⁺, Ba²⁺, Mg²⁺, Zn²⁺, and Al³⁺; q is an integer of 2 or 3; and t is an integer ranging from 0 to 6.

The sulfur-containing carboxylate salt represented by formula (10) is as follows:

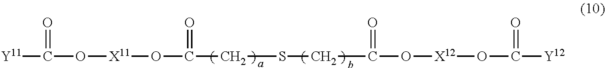

wherein X¹¹ and X¹² are independently selected from the group consisting of Ca²⁺, Ba²⁺, Mg²⁺, and Zn²⁺; Y¹¹ and Y¹² are independently selected from the group consisting of a C₁-C₃₀ alkyl group and a C₆-C₁₈ aryl group; and a and b are independently an integer ranging from 1 to 6.

The sulfur-containing carboxylate salt represented by formula (11) is as follows:

H-G¹-X²¹ₚ-G²-H (11)

wherein X₂₁ is selected from the group consisting of Ca²⁺, Ba²⁺, Mg²⁺, and Zn²⁺; G¹ and G² independently represent

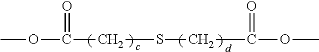

where c and d are independently an integer ranging from 1 to 6; and p is an integer ranging from 1 to 9 on the proviso that a plurality of G¹ are the same or different and a plurality of X²¹ are the same or different when p is an integer equal to or larger than 2.

The sulfur-containing carboxylate salt represented by formula (12) is as follows:

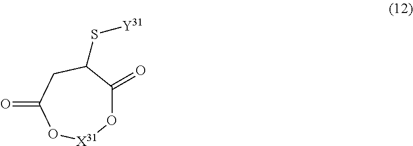

wherein X³¹ is selected from the group consisting of Ca²⁺, Ba²⁺, Mg²⁺, and Zn²⁺; and Y³¹ is selected from the group consisting of a C₁-C₃₀ alkyl group, a C₆-C₁₈ aryl group, and a group represented by R⁹³OOC—(CH₂)ₖ— where R⁹³ is selected from the group consisting of a C₁-C₃₀ alkyl group and a C₆-C₁₈ aryl group, and k is an integer ranging from 1 to 5.

The present disclosure further provides a modified polymer composition which is prepared from an olefin-based polymer using the aforesaid stabilizer mixture.

More details of the olefin-based polymer and the stabilizer mixture according to the present disclosure are described below.

### Olefin-Based Polymer:

The olefin-based polymer suitable for the disclosure is selected from the group consisting of polyolefins, ethylene-vinyl acetate copolymers, and combinations thereof.

### Stabilizer Mixture:

Examples of the organic phosphorus-containing antioxidant represented by formula (1) include, but are not limited to, tris(2,4-di-tert-butylphenyl) phosphite (Antioxidant 168), triphenyl phosphite, tris(4-tert-butylphenyl) phosphite, tris(nonylphenyl) phosphite, and tris(p-cumylphenyl) phosphite.

Examples of the organic phosphorus-containing antioxidant represented by formula (2) include, but are not limited to, bis(2,4-di-tert-butylphenyl)pentaerythritol diphosphite (Antioxidant 626), 3,9-bis(2,4-cumylphenoxy)-2,4,8,10-tetraoxatetradec-an-3,9-diphosphaspiro[5.5]undecane (Antioxidant 9228), diphenyl pentaerythritol diphosphite, and 2,4,8,10-tetraoxa-3,9-diphosphaspiro[5.5]undecane.

Examples of the organic phosphorus-containing antioxidant represented by formula (3) include, but are not limited to,

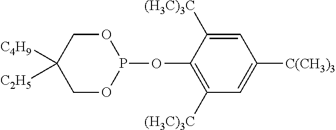

(CAS No. 161717-32-4), 2-[2,4-bis(1,1-dimethylethyl)phenoxy]-5,5-dimethyl-1,3,2-dioxaphosphorinane, 2,4-dicumylphenyl 2-butyl-2-ethyl-1,3-propanediol phosphite, and 2-[2,4-bis(1,1-dimethylethyl)phenoxy]-5-butyl-5-et-hyl-1,3,2-dioxaphosphorinane.

A non-limiting example of the organic phosphorus-containing antioxidant represented by formula (4) is

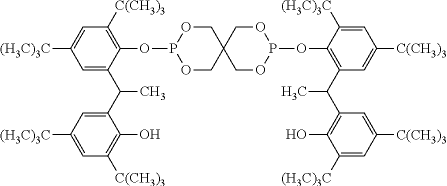 [SMILES: CC(c1cc(C(C)(C)C)cc(C(C)(C)C)c1O)c1cc(C(C)(C)C)cc(C(C)(C)C)c1OP1OCC2(CO1)COP(Oc1c(C(C)c3cc(C(C)(C)C)cc(C(C)(C)C)c3O)cc(C(C)(C)C)cc1C(C)(C)C)OC2]

### (CAS No. 1601458-04-1).

A non-limiting example of the organic phosphorus-containing antioxidant represented by formula (5) is

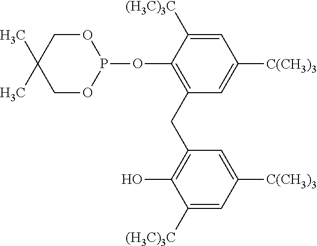 [SMILES: CC1(C)COP(Oc2c(Cc3cc(C(C)(C)C)cc(C(C)(C)C)c3O)cc(C(C)(C)C)cc2C(C)(C)C)OC1]

### (CAS No. 205518-79-2).

Examples of the organic phosphorus-containing antioxidant represented by formula (6) include, but are not limited to, 2,4,8,10-tetra-tert-butyl-6-[(2-ethylhexyl)oxy]-12H-dibenzo[d,g][1,3,2]dioxaphosphocin (HP-10), 2,2′-thiobis[6-tert-butyl-p-cresol] cyclic monophenyl phosphite, and 2,2′-methylene bis(4,6-di-tert-butylphenyl) (2,4-di-tert-butylphenyl) phosphite.

Examples of the organic phosphorus-containing antioxidant represented by formula (7) include, but are not limited to, Antioxidant P-EPQ, phosphonous acid, [1,1′-biphenyl]-4,4′-diylbis-,tetrakis[2-(1,1-dimethylethyl)phenyl] ester, and phosphonous acid, [1,1′-biphenyl]-4,4′-diylbis-,tetraphenyl ester.

In certain embodiments, R⁹¹ represents hydrogen, and R⁹² is selected from the group consisting of a C₁-C₁₈ alkyl group, a C₆-C₁₈ aryl group, and a group represented by R⁹³OOC—(CH₂)ₖ— where R⁹³ represents a C₁-C₁₈ alkyl group and k is 1 or 2. The term “aryl group” refers to a non-substituted aryl group, a hydrocarbon-substituted aryl group, or an aryl-substituted hydrocarbon group. In certain embodiments, R⁹² is selected from the group consisting of dodecyl and H₁₇C₈OOCCH₂—. Examples of the sulfur-containing carboxylate salt represented by formula (9) include, but are not limited to, (C₁₂H₂₅SCH₂COO)₂Zn, (C₁₂H₂₅SCH₂COO)₂Ca, (C₁₂H₂₅SCH₂CH₂COO)₂Zn, (C₁₂H₂₅SCH₂CH₂COO)₂Ca, and (C₁₂H₂₅SCH₂CH₂COO)₃Al.

In certain embodiments, X¹¹ and X¹² are independently selected from the group consisting of Ca²⁺ and Zn²⁺, and Y¹¹ and Y¹² are independently selected from the group consisting of —C₇H₁₅ and —C₁₇H₃₅. Examples of the sulfur-containing carboxylate salt represented by formula (10) include, but are not limited to.

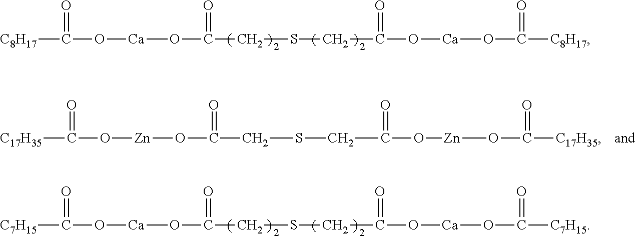

In certain embodiments, X²¹ is selected from the group consisting of Ca²⁺ and Zn²⁺, and G¹ and G² are independently

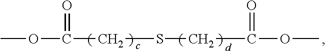

wherein c and d are independently 1 or 2. Examples of the sulfur-containing carboxylate salt represented by formula (11) include, but are not limited to,

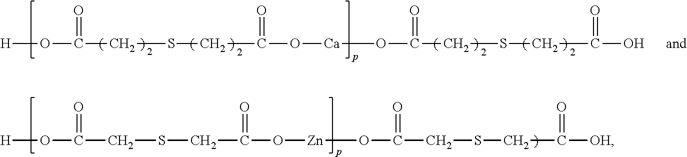

wherein p is an integer ranging from 1 to 9.

Examples of the sulfur-containing carboxylate salt represented by formula (12) include, but are not limited to,

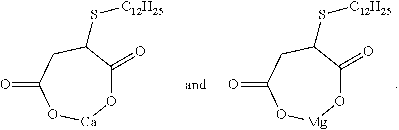

A ratio of the organic phosphorus-containing antioxidant to the sulfur-containing carboxylate salt ranges from 1:99 to 99:1.

In certain embodiments, the stabilizer mixture is present in an amount ranging from 0.01 to 2.2 parts by weight based on 100 parts by weight of the olefin-based polymer. There is no limitation to the method for preparing the modified polymer composition of the present disclosure. For example, the modified polymer composition may be preparing by mixing the olefin-based polymer with the stabilizer mixture.

There is no limitation to the subsequent processing method for the modified polymer composition. Any conventional processes for molding polyolefins and ethylene-vinyl acetate copolymers may be used. Examples of the molding processes include, but are not limited to, extrusion molding, injection molding, and the like.

Examples of the disclosure will be described hereinafter. It is to be understood that these examples are exemplary and explanatory and should not be construed as a limitation to the disclosure.

### Reagents Used in Following Examples

1. Polypropylene: B8001 commercially available from Formosa Chemicals & Fibre Corp., referred to as PP in Tables 1 and 2;
2. Polyethylene: LL120 commercially available from Formosa Chemicals & Fibre Corp., referred to as PE in Tables 1 and 2;
3. Tris(2,4-di-tert-butylphenyl) phosphite (Antioxidant 168): an example of the organic phosphorus-containing antioxidant represented by formula (1), referred to as A1 in Tables 1 and 2;
4. Bis(2,4-di-tert-butylphenyl)pentaerythritol diphosphite (Antioxidant 626): an example of the organic phosphorus-containing antioxidant represented by formula (2), referred to as A2 in Tables 1 and 2;
5. 3,9-bis(2,4-cumylphenoxy)-2,4,8,10-tetraoxatetra-decan-3,9-diphosphaspiro[5.5]undecane (Antioxidant 9228): an example of the organic phosphorus-containing antioxidant represented by formula (2), referred to as A3 in Tables 1 and 2;
6. 2,4,8,10-tetra-tert-butyl-6-[(2-ethylhexyl)oxy]-12H-dibenzo[d,g][1,3,2]dioxaphosphocin (HP-10): an example of the organic phosphorus-containing antioxidant represented by formula (6), referred to as A4 in Tables 1 and 2;

### 7. Antioxidant P-EPQ:

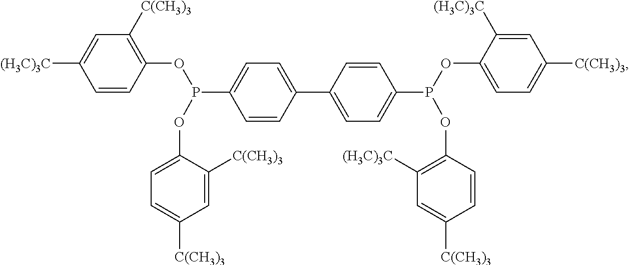 [SMILES: CC(C)(C)c1ccc(OP(Oc2ccc(C(C)(C)C)cc2C(C)(C)C)c2ccc(-c3ccc(P(Oc4ccc(C(C)(C)C)cc4C(C)(C)C)Oc4ccc(C(C)(C)C)cc4C(C)(C)C)cc3)cc2)c(C(C)(C)C)c1]

an example of the organic phosphorus-containing antioxidant represented by formula (7), referred to as A5 in Tables 1 and 2;
8. 9,10-dihydro-9-oxa-10-phosphaphenanthrene-10 oxide (DOPO): the organic phosphorus-containing antioxidant represented by formula (8), referred to as A6 in Tables 1 and 2;
9.

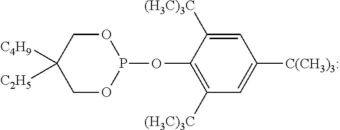

CAS No. 161717-32-4, an example of the organic phosphorus-containing antioxidant represented by formula (3), referred to as A7 in Tables 1 and 2;
10.

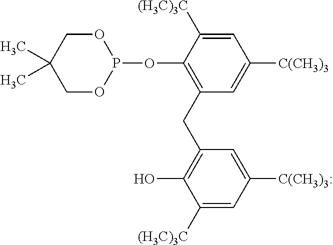

CAS No. 205518-79-2, an example of the organic phosphorus-containing antioxidant represented by formula (5), referred to as A8 in Tables 1 and 2;
11.

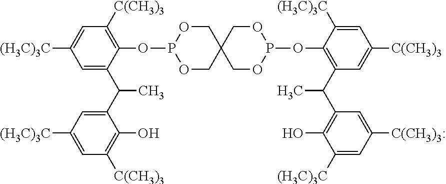

CAS No. 1601458-04-1, an example of the organic phosphorus-containing antioxidant represented by formula (4), referred to as A9 in Tables 1 and 2;
12. (C₁₂H₂₅SCH₂CH₂COO)₂Ca: an example of the sulfur-containing carboxylate salt represented by formula (9), referred to as B1 in Tables 1 and 2;
13. (C₁₂H₂₅SCH₂CH₂COO)₃Al: an example of the sulfur-containing carboxylate salt represented by formula (9), referred to as B2 in Tables 1 and 2;
14.

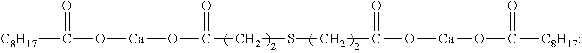

an example of the sulfur-containing carboxylate salt represented by formula (10), referred to as B3 in Tables 1 and 2;
15.

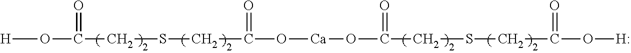

an example of the sulfur-containing carboxylate salt represented by formula (11), referred to as B4 in Tables 1 and 2;
16.

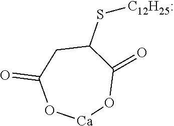

an example of the sulfur-containing carboxylate salt represented by formula (12), referred to as B5 in Tables 1 and 2; and
17. Distearyl thiodipropionate: referred to as DSTDP.

### Examples 1-18

In each of Examples 1-16, 100 parts by weight of polypropylene was uniformly mixed with a stabilizer mixture in an amount shown in Table 1 at 25° C. to prepare a modified polymer composition of the present disclosure. In each of Examples 17 and 18, 100 parts by weight of polyethylene was uniformly mixed with a stabilizer mixture in an amount shown in Table 1 at 25° C. to prepare a modified polymer composition of the present disclosure.

### Comparative Examples 1-21

In each of Comparative Examples 1-17 and 20-21, 100 parts by weight of polypropylene was uniformly mixed with a stabilizer(s) (i.e. an organic phosphorus-containing antioxidant alone, a sulfur-containing carboxylate ester alone, a sulfur-containing carboxylate salt alone, or a combination of an organic phosphorus-containing antioxidant and a sulfur-containing carboxylate ester) in an amount shown in Table 2 at 25° C. to prepare a modified polymer composition. In each of Comparative Examples 18 and 19, 100 parts by weight of polyethylene was uniformly mixed with a stabilizer (i.e. an organic phosphorus-containing antioxidant alone) in an amount shown in Table 2 at 25° C. to prepare a modified polymer composition.

### Evaluation Tests:

Each of the modified polymer compositions prepared in Examples 1-18 and Comparative Examples 1-21 was extruded using a twin-screw extruder (Model No. PSM20A, produced by Sino-Alloy Machinery Inc.; temperature: 190-230° C., extruder screw speed: 200 rpm, feed rate: 6 rpm), followed by cooling, air-drying, pelletization, and oven drying. Therefore, a specimen was prepared. The specimen was further processed repeatedly by the steps of extrusion, cooling, air-drying, pelletization, and oven-drying to evaluate variations in yellowness and melt index after several times of processing. The smaller the variation in the yellowness of the specimen is, the better the color stability of the specimen is. Similarly, the smaller the variation in the melt index of the specimen is, the better the processing stability of the specimen is.

### 1. Yellowness Difference (Δb*)

For the specimen of each of the modified polymer compositions prepared in Examples 1-18 and Comparative Examples 1-21, the yellowness difference (Δb*) between the yellowness of the specimen obtained after the third extrusion process and that of the specimen obtained after the first extrusion process was determined using a spectrophotometer (ColorQuest XE produced by HunterLab). Likely, for the specimen of each of the modified polymer compositions prepared in Examples 1-18 and Comparative Examples 1-21, the yellowness difference (Δb*) between the yellowness of the specimen obtained after the fifth extrusion process and that of the specimen obtained after the first extrusion process was determined using a spectrophotometer (ColorQuest XE produced by HunterLab). The results are shown in Tables 3 and 4.

### 2. Melt Index Difference (ΔMI)

For the specimen of each of the modified polymer compositions prepared in Examples 1-18 and Comparative Examples 1-21, the melt index difference (ΔMI) between the melt index of the specimen obtained after the third extrusion process and that of the specimen obtained after the first extrusion process was determined using Laboratory Melt Indexer LMI D4004 produced by Dynisco. Likely, for each of the modified polymer compositions prepared in Examples 1-18 and Comparative Examples 1-21, the melt index difference (ΔMI) of the specimen between the melt index of the specimen obtained after the fifth extrusion process and that of the specimen obtained after the first extrusion process was determined using Laboratory Melt Indexer LMI D4004 produced by Dynisco. The melt index difference is defined as the ratio of the melt index of the specimen obtained after a respective subsequent extrusion process (third or fifth) to the melt index of the specimen obtained after the first extrusion process. The results are shown in Tables 3 and 4.

TABLE 1

| | | | Stabilizer Mixture | | | | | | | | | | | | | |
|---|---|---|---|---|---|---|---|---|---|---|---|---|---|---|---|---|
| | | | | | | | | | | | | Sulfur-containing | | | | |
| | Polymer | | Organic phosphorus-containing antioxidant | | | | | | | | | carboxylate salt | | | | |
| Exs. | PP | PE | A1 | A2 | A3 | A4 | A5 | A6 | A7 | A8 | A9 | B1 | B2 | B3 | B4 | B5 |
| 1 | 100 | — | 0.02 | — | — | — | — | — | — | — | — | 0.02 | — | — | — | — |
| 2 | 100 | — | — | 0.02 | — | — | — | — | — | — | — | 0.02 | — | — | — | — |
| 3 | 100 | — | — | — | 0.02 | — | — | — | — | — | — | 0.02 | — | — | — | — |
| 4 | 100 | — | — | — | — | 0.02 | — | — | — | — | — | 0.02 | — | — | — | — |
| 5 | 100 | — | — | — | — | — | 0.02 | — | — | — | — | 0.02 | — | — | — | — |
| 6 | 100 | — | — | — | — | — | — | 0.02 | — | — | — | 0.02 | — | — | — | — |
| 7 | 100 | — | — | — | — | — | — | — | 0.02 | — | — | 0.02 | — | — | — | — |
| 8 | 100 | — | — | — | — | — | — | — | — | 0.02 | — | 0.02 | — | — | — | — |
| 9 | 100 | — | — | — | — | — | — | — | — | — | 0.02 | 0.02 | — | — | — | — |
| 10 | 100 | — | 0.02 | — | — | — | — | — | — | — | — | — | 0.02 | — | — | — |
| 11 | 100 | — | 0.02 | — | — | — | — | — | — | — | — | — | — | 0.02 | — | — |
| 12 | 100 | — | 0.02 | — | — | — | — | — | — | — | — | — | — | — | 0.02 | — |
| 13 | 100 | — | 0.02 | — | — | — | — | — | — | — | — | — | — | — | — | 0.02 |
| 14 | 100 | — | 1 | — | — | — | — | — | — | — | — | 1 | — | — | — | — |
| 15 | 100 | — | 0.01 | — | — | — | — | — | — | — | — | 0.99 | — | — | — | — |
| 16 | 100 | — | 0.99 | — | — | — | — | — | — | — | — | 0.01 | — | — | — | — |
| 17 | — | 100 | 0.02 | — | — | — | — | — | — | — | — | 0.02 | — | — | — | — |
| 18 | — | 100 | — | 0.02 | — | — | — | — | — | — | — | 0.02 | — | — | — | — |

TABLE 2

| | | | Stabilizer(s) | | | | | | | | | | | | | | |
|---|---|---|---|---|---|---|---|---|---|---|---|---|---|---|---|---|---|
| | | | | | | | | | | | | Sulfur- | | | | | |
| | | | | | | | | | | | | containing | | | | | |
| | | | | | | | | | | | | carboxylate | | | | | |
| Comp. | Polymer | | Organic phosphorus-containing antioxidant | | | | | | | | | ester | Sulfur-containing carboxylate salt | | | | |
| Exs. | PP | PE | A1 | A2 | A3 | A4 | A5 | A6 | A7 | A8 | A9 | DSTDP | B1 | B2 | B3 | B4 | B5 |
| 1 | 100 | — | 0.02 | — | — | — | — | — | — | — | — | — | — | — | — | — | — |
| 2 | 100 | — | — | 0.02 | — | — | — | — | — | — | — | — | — | — | — | — | — |
| 3 | 100 | — | — | — | 0.02 | — | — | — | — | — | — | — | — | — | — | — | — |
| 4 | 100 | — | — | — | — | 0.02 | — | — | — | — | — | — | — | — | — | — | — |
| 5 | 100 | — | — | — | — | — | 0.02 | — | — | — | — | — | — | — | — | — | — |
| 6 | 100 | — | — | — | — | — | — | 0.02 | — | — | — | — | — | — | — | — | — |
| 7 | 100 | — | — | — | — | — | — | — | 0.02 | — | — | — | — | — | — | — | — |
| 8 | 100 | — | — | — | — | — | — | — | — | 0.02 | — | — | — | — | — | — | — |
| 9 | 100 | — | — | — | — | — | — | — | — | — | 0.02 | — | — | — | — | — | — |
| 10 | 100 | — | — | — | — | — | — | — | — | — | — | 0.02 | — | — | — | — | — |
| 11 | 100 | — | 0.02 | — | — | — | — | — | — | — | — | 0.02 | — | — | — | — | — |
| 12 | 100 | — | — | 0.02 | — | — | — | — | — | — | — | 0.02 | — | — | — | — | — |
| 13 | 100 | — | — | — | — | — | — | — | — | — | — | — | 0.02 | — | — | — | — |
| 14 | 100 | — | — | — | — | — | — | — | — | — | — | — | — | 0.02 | — | — | — |
| 15 | 100 | — | — | — | — | — | — | — | — | — | — | — | — | — | 0.02 | — | — |
| 16 | 100 | — | — | — | — | — | — | — | — | — | — | — | — | — | — | 0.02 | — |
| 17 | 100 | — | — | — | — | — | — | — | — | — | — | — | — | — | — | — | 0.02 |
| 18 | — | 100 | 0.02 | — | — | — | — | — | — | — | — | — | — | — | — | — | — |
| 19 | — | 100 | — | 0.02 | — | — | — | — | — | — | — | — | — | — | — | — | — |
| 20 | 100 | — | 1 | — | — | — | — | — | — | — | — | — | — | — | — | — | — |
| 21 | 100 | — | — | — | — | — | — | — | — | — | — | — | 1 | — | — | — | — |

TABLE 3

| | Δb* | | ΔMI | |
|---|---|---|---|---|
| Specimens | 3^{rd} Extrusion | 5^{th} Extrusion | 3^{rd} Extrusion | 5^{th} Extrusion |
| E1 | 2.66 | 5.04 | 161.58% | 258.64% |
| E2 | 2.46 | 4.35 | 148.93% | 235.25% |
| E3 | 1.81 | 3.74 | 112.29% | 182.76% |
| E4 | 1.94 | 3.86 | 153.72% | 240.15% |
| E5 | 2.30 | 4.54 | 113.83% | 189.73% |
| E6 | 2.58 | 4.58 | 153.88% | 249.23% |
| E7 | 2.58 | 4.49 | 151.58% | 257.11% |
| E8 | 2.44 | 4.38 | 147.91% | 237.09% |
| E9 | 2.50 | 4.43 | 150.75% | 240.42% |
| E10 | 2.45 | 4.40 | 150.97% | 239.48% |
| E11 | 2.43 | 4.41 | 131.12% | 222.54% |
| E12 | 2.36 | 4.21 | 132.65% | 201.42% |
| E13 | 2.51 | 4.36 | 125.78% | 225.67% |
| E14 | 1.58 | 3.62 | 106.55% | 180.65% |
| E15 | 2.31 | 4.08 | 138.87% | 227.86% |
| E16 | 2.36 | 4.32 | 145.48% | 231.17% |
| E17 | 2.25 | 3.77 | 134.09% | 183.12% |
| E18 | 2.06 | 3.66 | 123.29% | 175.61% |

TABLE 4

| | Δb* | | ΔMI | |
|---|---|---|---|---|
| Specimens | 3^{rd} Extrusion | 5^{th} Extrusion | 3^{rd} Extrusion | 5^{th} Extrusion |
| CE1 | 4.40 | 7.68 | 183.87% | 377.11% |
| CE2 | 4.70 | 7.72 | 182.62% | 381.96% |
| CE3 | 3.58 | 6.65 | 187.39% | 358.10% |
| CE4 | 3.63 | 6.74 | 186.91% | 365.29% |
| CE5 | 4.54 | 7.72 | 187.41% | 382.88% |
| CE6 | 4.24 | 7.57 | 188.09% | 389.26% |
| CE7 | 4.18 | 7.50 | 185.50% | 384.89% |
| CE8 | 3.78 | 6.74 | 205.33% | 392.88% |
| CE9 | 3.60 | 6.55 | 201.60% | 389.75% |
| CE10 | 3.63 | 6.62 | 202.46% | 382.88% |
| CE11 | 3.82 | 6.60 | 175.79% | 368.26% |
| CE12 | 3.12 | 5.92 | 180.70% | 314.41% |
| CE13 | 3.99 | 6.73 | 178.09% | 374.07% |
| CE14 | 3.28 | 6.12 | 181.80% | 322.84% |
| CE15 | 3.75 | 6.45 | 188.56% | 386.12% |
| CE16 | 3.28 | 6.12 | 177.42% | 333.76% |
| CE17 | 3.28 | 6.12 | 182.91% | 336.21% |
| CE18 | 3.45 | 6.50 | 176.28% | 371.97% |
| CE19 | 3.65 | 6.49 | 179.88% | 380.39% |
| CE20 | 4.99 | 9.89 | 177.94% | 315.65% |
| CE21 | 4.12 | 7.13 | 169.43% | 317.12% |

As shown in Tables 3 and 4, for the specimens E1-E18 prepared from the modified polymer compositions of Examples 1-18, Δb* values of the specimens after the third extrusion process are all smaller than 2.66, and Δb* values of the specimens after the fifth extrusion process are all smaller than 5.04. However, for the specimens CE1-CE21 prepared from the modified polymer compositions of Comparative Examples 1-21, Δb* values of the specimens after the third extrusion process are all larger than 3.12, and Δb* values of the specimens after the fifth extrusion process are all larger than 6.12. Evidently, the modified polymer compositions of Examples 1-18 (which were prepared using a stabilizer mixture of the disclosure) have improved color stability compared to that of the modified polymer compositions of Comparative Examples 1-21.

Particularly, each of the specimens E1 and E10 prepared from the modified polymer compositions of Examples 1 and 10 (which contain the organic phosphorus-containing antioxidant A1 and one of the sulfur-containing carboxylate salts B1 and B2) has a better color stability compared to the specimen CE11 prepared from the modified polymer composition of Comparative Example 11 (which also contains the organic phosphorus-containing antioxidant A1, but with the sulfur-containing carboxylate ester DSTDP rather than a sulfur-containing carboxylate salt). Therefore, it can be indicated that a sulfur-containing carboxylate salt, when used in combination with an organic phosphorus-containing antioxidant, can synergistically render a modified polymer composition more resistant to coloration compared to a corresponding sulfur-containing carboxylate ester. A similar conclusion can be drawn based on the difference in color stability between the specimen E2 prepared from the modified polymer composition of Example 2 (which contains the organic phosphorus-containing antioxidant A2 and the sulfur-containing carboxylate salt B1) and the specimen CE12 prepared from the modified polymer composition of Comparative Example 12 (which also contains the organic phosphorus-containing antioxidant A2, but with the sulfur-containing carboxylate ester DSTDP rather than a sulfur-containing carboxylate salt).

Considering the processing stability in terms of melt index difference, for the specimens E1-E18 prepared from the modified polymer compositions of Examples 1-18, ΔMI values of the specimens after the third extrusion process are all smaller than 161.58%, and ΔMI values of the specimens after the fifth extrusion process are all smaller than 258.64%. However, for the specimens CE1-CE21 prepared from the modified polymer compositions of Comparative Examples 1-21, ΔMI values of the specimens after the third extrusion process are all larger than 175.79%, and ΔMI values of the specimens after the fifth extrusion process are all larger than 314.41%. Evidently, the modified polymer compositions of Examples 1-18 (which were prepared using a stabilizer mixture of the disclosure) has improved processing stability compared to that of the modified polymer compositions of Comparative Examples 1-21.

Particularly, each of the specimens E1 and E10 prepared from the modified polymer compositions of Examples 1 and 10 (which contain the organic phosphorus-containing antioxidant A1 and one of the sulfur-containing carboxylate salts B1 and B2) has a better processing stability compared to the specimen CE11 prepared from the modified polymer composition of Comparative Example 11 (which also contains the organic phosphorus-containing antioxidant A1, but with the sulfur-containing carboxylate ester DSTDP rather than a sulfur-containing carboxylate salt). Therefore, it can be indicated that a sulfur-containing carboxylate salt, when used in combination with an organic phosphorus-containing antioxidant, can synergistically render a modified polymer composition more resistant to change in melt index compared to a corresponding sulfur-containing carboxylate ester. A similar conclusion can be drawn based on the difference in processing stability between the specimen E2 prepared from the modified polymer composition of Example 2 (which contains the organic phosphorus-containing antioxidant A2 and the sulfur-containing carboxylate salt B1) and the specimen CE12 prepared from the modified polymer composition of Comparative Example 12 (which also contains the organic phosphorus-containing antioxidant A2, but with the sulfur-containing carboxylate ester DSTDP rather than a sulfur-containing carboxylate salt).

In addition to the aforesaid processing stability provided by the stabilizer mixture of the present disclosure as illustrated by the ΔMI values in Table 3, the MI values of the specimens E1-E18 prepared from the modified polymer compositions of Examples 1-18, which were used to calculate the ΔMI values in Table 3, are shown in Table 5 for further demonstrating the meritorious effect of the stabilizer mixture of the present disclosure.

TABLE 5

| | MI | | |
|---|---|---|---|
| Specimens | 1^{th} Extrusion | 3^{rd} Extrusion | 5^{th} Extrusion |
| E1 | 0.2803 | 0.4529 | 0.7250 |
| E2 | 0.2624 | 0.3908 | 0.6173 |
| E3 | 0.2616 | 0.2938 | 0.4781 |
| E4 | 0.2933 | 0.4509 | 0.7044 |
| E5 | 0.3142 | 0.3577 | 0.5961 |
| E6 | 0.3184 | 0.4900 | 0.7935 |
| E7 | 0.3008 | 0.4560 | 0.7734 |
| E8 | 0.2794 | 0.4133 | 0.6624 |
| E9 | 0.3145 | 0.4741 | 0.7561 |
| E10 | 0.2911 | 0.4395 | 0.6971 |
| E11 | 0.3082 | 0.4041 | 0.6859 |
| E12 | 0.3025 | 0.4013 | 0.6093 |
| E13 | 0.2838 | 0.3570 | 0.6405 |
| E14 | 0.2249 | 0.2396 | 0.4063 |
| E15 | 0.3025 | 0.4201 | 0.6893 |
| E16 | 0.2417 | 0.3516 | 0.5587 |
| E17 | 2.1055 | 2.8233 | 3.8556 |
| E18 | 2.4221 | 2.9862 | 4.2534 |

The low MI values of the specimens E1-E18 shown in Table 5 indicate that the stabilizer mixture of the present disclosure can impart a satisfactory physical property to a polymer composition (i.e. the lower the MI value is, the better the physical property of a polymer composition is). Moreover, compared to the specimen CE11 (containing the organic phosphorus-containing antioxidant A1, but with the sulfur-containing carboxylate ester DSTDP rather than a sulfur-containing carboxylate salt), the MI values of which after the first, third, and fifth extrusion processes are 0.3828, 0.6729, and 1.4097, each of the specimens E1 and E10 (which contain the organic phosphorus-containing antioxidant A1 and one of the sulfur-containing carboxylate salts B1 and B2) has a lower MI value after several times of extrusion. Likewise, compared to the specimen CE12 (containing the organic phosphorus-containing antioxidant A2, but with the sulfur-containing carboxylate ester DSTDP rather than a sulfur-containing carboxylate salt), the MI values of which after the first, third, and fifth extrusion processes are 0.3616, 0.6534, and 1.1369, the specimen E2 (which contains the organic phosphorus-containing antioxidant A2 and the sulfur-containing carboxylate salt B1) has a lower MI value after several times of extrusion. Thus, the stabilizer mixture of the present disclosure not only provides processing stability for a polymer composition, but also confers a satisfactory physical property on the polymer composition.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A stabilizer mixture for modifying an olefin-based polymer, the stabilizer mixture comprising:
at least one organic phosphorus-containing antioxidant represented by a formula selected from the group consisting of formulae (1), (2), (3), (4), (5), (6), (7), and (8), 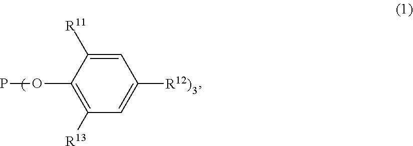
wherein R¹¹, R¹², and R¹³ are independently selected from the group consisting of hydrogen, a tert-butyl group, an isopropylphenyl group, and a linear C₁-C₈ alkyl group, 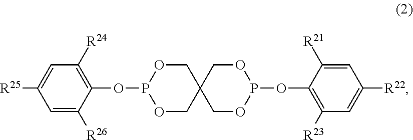
wherein R²¹, R²², R²³, R²⁴, R²⁵, and R²⁶ are independently selected from the group consisting of hydrogen, a tert-butyl group, an isopropylphenyl group, and a linear C₁-C₈ alkyl group, 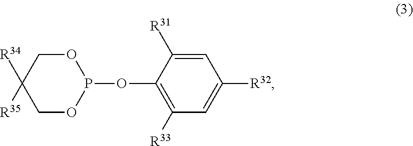
wherein R³¹, R³², R³³, R³⁴, and R³⁵ are independently selected from the group consisting of hydrogen, a tert-butyl group, an isopropylphenyl group, and a linear C₁-C₈ alkyl group, 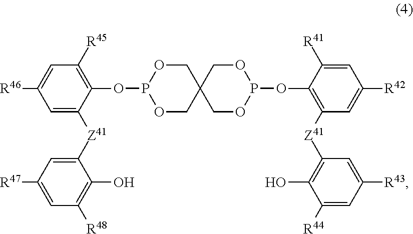
wherein
R⁴¹, R⁴², R⁴³, R⁴⁴, R⁴⁵, R⁴⁶, R⁴⁷, and R⁴⁸ are independently selected from the group consisting of hydrogen, a tert-butyl group, an isopropylphenyl group, and a linear C₁-C₈ alkyl group, and
Z⁴¹ and Z⁴² are independently selected from the group consisting of O, S, and a C₁-C₄ alkylene group, 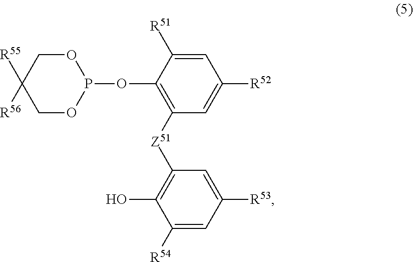
wherein
R⁵¹, R⁵², R⁵³, R⁵⁴, R⁵⁵, and R⁵⁶ are independently selected from the group consisting of hydrogen, a tert-butyl group, an isopropylphenyl group, and a linear C₁-C₈ alkyl group, and
Z⁵¹ is selected from the group consisting of O, S, and a C₁-C₄ alkylene group, 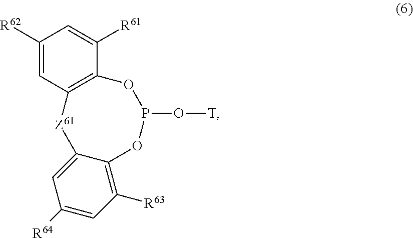
wherein
R⁶¹, R⁶², R⁶³, and R⁶⁴ are independently selected from the group consisting of hydrogen, a tert-butyl group, an isopropylphenyl group, and a linear C₁-C₈ alkyl group, and
Z⁶¹ is selected from the group consisting of O, S, and a C₁-C₄ alkylene group, 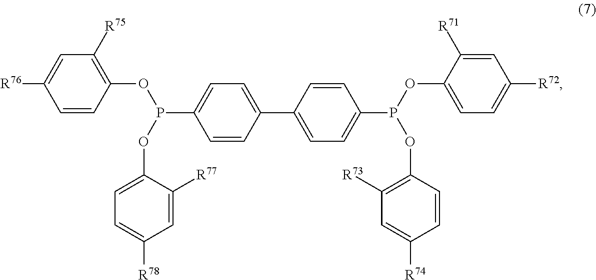
wherein R⁷¹, R⁷², R⁷³, R⁷⁴, R⁷⁵, R⁷⁶, R⁷⁷, and R⁷⁸ are independently selected from the group consisting of hydrogen, a tert-butyl group, an isopropylphenyl group, and a linear C₁-C₈ alkyl group, and 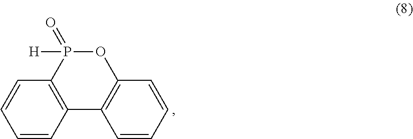 [SMILES: O=[PH]1Oc2ccccc2-c2ccccc21]
and
at least one sulfur-containing carboxylate salt represented by a formula selected from the group consisting of formulae (9), (10), (11), and (12)
[R⁹²—S—CHR⁹¹—(CH₂)ₜ—COO⁻]_{q}M^{q+} (9),
wherein
R⁹¹ is selected from the group consisting of hydrogen and a C₁-C₁₈ alkyl group,
R⁹² is selected from the group consisting of a C₁-C₃₀ alkyl group, a C₆-C₁₈ aryl group, and a group represented by R⁹³OOC—(CH₂)ₖ— where R⁹³ is selected from the group consisting of a C₁-C₃₀ alkyl group and a C₆-C₁₈ aryl group, and k is an integer ranging from 1 to 5,
M^{q+} is selected from the group consisting of Ca²⁺, Ba²⁺, Mg²⁺, Zn²⁺, and Al³⁺,
q is an integer of 2 or 3, and
t is an integer ranging from 0 to 6, 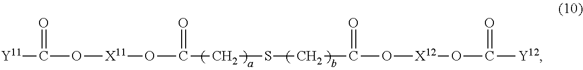
wherein
X¹¹ and X¹² are independently selected from the group consisting of Ca²⁺, Ba²⁺, Mg²⁺, and Zn²⁺,
Y¹¹ and Y¹² are independently selected from the group consisting of a C₁-C₃₀ alkyl group and a C₆-C₁₈ aryl group, and
a and b are independently an integer ranging from 1 to 6,
H-G¹-X²¹ₚ-G²-H (11),
wherein
X₂₁ is selected from the group consisting of Ca²⁺, Ba²⁺, Mg²⁺, and Zn²⁺,
G¹ and G² independently represent 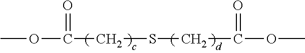
where c and d are independently an integer ranging from 1 to 6, and
p is an integer ranging from 1 to 9 on the proviso that a plurality of G¹ are the same or different and a plurality of X²¹ are the same or different when p is an integer equal to or larger than 2,
and 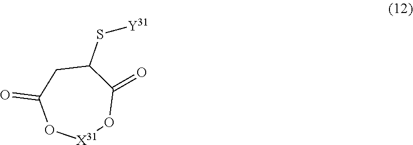
wherein
X³¹ is selected from the group consisting of Ca²⁺, Ba²⁺, Mg²⁺, and Zn²⁺, and
Y³¹ is selected from the group consisting of a C₁-C₃₀ alkyl group, a C₆-C₁₈ aryl group, and a group represented by R⁹³OOC—(CH₂)ₖ— where R⁹³ is selected from the group consisting of a C₁-C₃₀ alkyl group and a C₆-C₁₈ aryl group, and k is an integer ranging from 1 to 5.

2. The stabilizer mixture according to claim 1, wherein R⁹¹ represents hydrogen, and R⁹² is selected from the group consisting of a C₁-C₁₈ alkyl group, a C₆-C₁₈ aryl group, and a group represented by R⁹³OOC—(CH₂)ₖ— where R⁹³ represents a C₁-C₁₈ alkyl group and k is 1 or 2.

3. The stabilizer mixture according to claim 2, wherein R92 is selected from the group consisting of dodecyl and H₁₇C₈OOCCH₂—.

4. A modified polymer composition, comprising:
an olefin-based polymer selected from the group consisting of polyolefin, ethylene-vinyl acetate copolymer, and a combination thereof; and
the stabilizer mixture according to claim 1.

5. The modified polymer composition according to claim 4, wherein said stabilizer mixture is present in an amount ranging from 0.01 to 2.2 parts by weight based on 100 parts by weight of said olefin-based polymer.

6. The modified polymer composition according to claim 4, wherein said polyolefin is selected from the group consisting of polyethylene, polypropylene, and a combination thereof.
